(19) United States
(12) Patent Application Publication
(10) Pub. No.: US 2026/0163125 A1
(43) Pub. Date: Jun. 11, 2026

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 19/464,093

(22) Filed: Jan. 29, 2026

Related U.S. Application Data
(63) Continuation of application No. PCT/JP2024/023488, filed on Jun. 28, 2024.

(30) Foreign Application Priority Data
Oct. 3, 2023 (JP) 2023-172189

(51) Int. Cl. H01M 10/659; H01M 10/643

(52) U.S. Cl. CPC H01M 10/659; H01M 10/643

(57) ABSTRACT

Provided is a battery pack in which the mechanical strength of a container for housing a heat absorbing agent is further improved, and deformation of the container when the heat absorbing agent is housed in the container, and deformation of the container against vibration and impact during normal use of the battery pack are further reduced. A battery pack of the present disclosure includes: a plurality of batteries; and a heat absorbing member having a heat absorbing agent and a container that houses the heat absorbing agent, in which the heat absorbing member is disposed at a position adjacent to the batteries, the container has a triangular prism shape and has a plurality of housing portions AP that house the heat absorbing agent, respective vertex portions PP of the housing portions AP having the triangular prism shape are disposed at positions adjacent to each other, and two surfaces constituting the vertex portion PP are not adjacent to the batteries.

### CROSS REFERENCE TO RELATED APPLICATIONS

The present application is a continuation of International Patent Application No. PCT/JP2024/023488, filed on Jun. 28, 2024, which claims priority to Japanese Patent Application No. 2023-172189, filed on Oct. 3, 2023, the entire contents of which are incorporate herein by reference.

### BACKGROUND

The present disclosure relates to a battery pack.

A battery pack is disclosed including: a plurality of batteries; an upper partition plate and a lower partition plate that are disposed between the plurality of batteries and separate the plurality of batteries from each other; and a heat absorbing agent that is housed in the upper partition plate and the lower partition plate and cools the plurality of batteries, the battery pack having the heat absorbing agent for cooling the plurality of batteries in a housing space of the upper partition plate and a housing space of the lower partition plate.

According to the battery pack, when an abnormality caused by heat generation of the battery occurs, the battery as a heat generation source can be cooled by the heat absorbing agent.

### SUMMARY

The present disclosure relates to a battery pack.

The battery pack referenced in the Background section has no support or the like in the housing space for housing the heat absorbing agent, and there is room for improvement in the mechanical strength of the housing space.

The present disclosure has been made in view of such a viewpoint and relates to providing a battery pack that further improves the mechanical strength of a container for housing a heat absorbing agent, and further reduces deformation of the container when the heat absorbing agent is housed in the container, and deformation of the container against vibration and impact during normal use of the battery pack according to an embodiment.

The battery pack of the present disclosure includes, in an embodiment:
a plurality of batteries; and
a heat absorbing member having a heat absorbing agent and a container for housing the heat absorbing agent, in which
the heat absorbing member is disposed at a position adjacent to the battery,
the container has a triangular prism shape and has a plurality of housing portions for housing the heat absorbing agent, and
respective vertex portions of the housing portions having the triangular prism shape are disposed at positions adjacent to each other and two surfaces constituting the vertex portion are not adjacent to the battery.

In an embodiment, the battery pack of the present disclosure includes:
a plurality of batteries; and
a plurality of heat absorbing members each having a heat absorbing agent and a container for housing the heat absorbing agent, in which
each of the plurality of heat absorbing members is disposed at a position adjacent to one of the plurality of batteries; each of the plurality of containers has a triangular prism shape, one vertex portion of one container having the triangular prism shape and one vertex portion of the other container having the triangular prism shape are disposed at positions adjacent to each other; and two surfaces constituting the vertex portion are not adjacent to the battery; and the adjacent heat absorbing members are in contact with each other.

The present disclosure, in an embodiment, can provide a battery pack in which the mechanical strength of a container for housing a heat absorbing agent is further improved, and deformation of the container when the heat absorbing agent is housed in the container, and deformation of the container against vibration and impact during normal use of the battery pack are further reduced.

### BRIEF DESCRIPTION OF THE FIGURES

FIG. 1 is a schematic exploded perspective view of a battery pack.

FIG. 2 is a schematic exploded perspective view of a core pack housed in a battery pack.

FIG. 3 is a schematic exploded perspective view of the heat absorbing member of an embodiment.

FIG. 4 is a schematic perspective view of a heat absorbing member of an embodiment.

FIG. 5 is a schematic sectional view of the heat absorbing member of an embodiment.

FIG. 6 is a schematic explanatory view for explaining a state in which the heat absorbing member of an embodiment is folded.

FIG. 7 is a schematic sectional view of a main portion of the battery pack of an embodiment of the present disclosure.

FIG. 8 is a schematic sectional view of the main portion when an abnormality occurs in the battery pack.

FIG. 9 is a schematic sectional view of a main portion of a conventional battery pack.

FIG. 10 is a schematic exploded perspective view of a heat absorbing member of an embodiment.

FIG. 11 is a schematic perspective view of a heat absorbing member of an embodiment.

### DETAILED DESCRIPTION

Hereinafter, a battery pack according to an embodiment of the present disclosure will be described in more detail. Although description will be made with reference to the drawings as necessary, various elements in the drawings are merely schematically and exemplarily illustrated for understanding of the present disclosure, and appearance, a dimensional ratio, and the like can be different from those of actual ones.

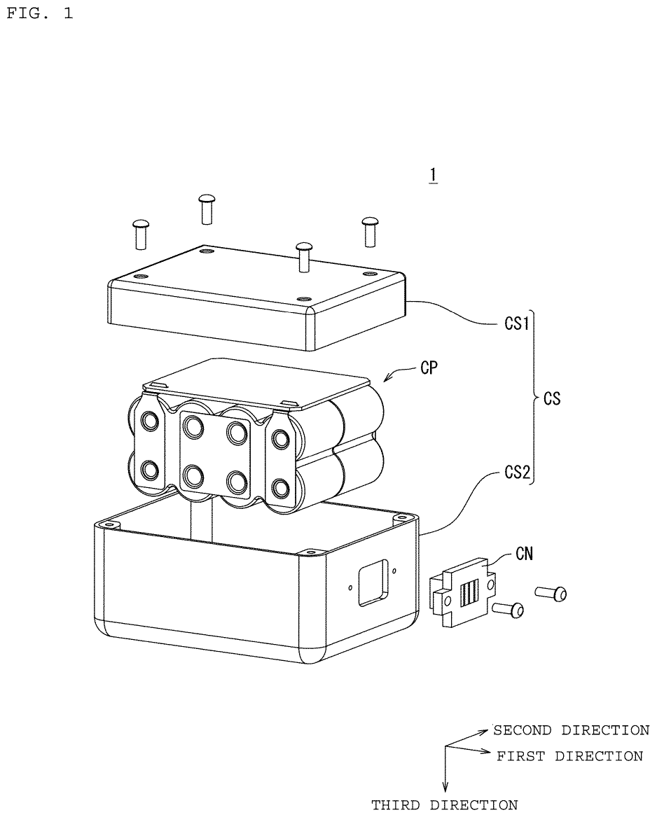

The term “in a plan view” in the present invention refers to a state when an object (for example, a battery pack) is placed at a location and viewed from directly above in its thickness (height) direction, and is synonymous with a plan view. As an example, the plan view is in a state when viewed along a positive direction in a “third direction” illustrated in FIG. 1. The term “view from the side” in the present description refers to a state when an object (for example, a battery pack) is placed and viewed from the side perpendicular to its thickness (height) direction unless otherwise specified, and has the same meaning as the side view. As an example, a view from the side is a state when viewed along a positive direction (or a negative direction) in a “first direction” illustrated in FIG. 1. The term “in a front view” as used herein refers to a state when the object (for example, the battery pack) is placed at a location and viewed from a front perpendicular to the thickness (height) direction unless otherwise specified, and is synonymous with a front view. As an example, the front view is in a state when viewed along a positive direction in a “second direction” illustrated in FIG. 1. Note that the above-described “positive direction” is intended to be a direction of an arrow in the first direction, the second direction, and the third direction illustrated in the drawings, and the “negative direction” is intended to be a direction opposite to a direction of an arrow in the first direction, the second direction, and the third direction illustrated in the drawings. Further, the first direction, the second direction, and the third direction are orthogonal to each other. Further, a term such as “about” and “approximately” means that it may include variation of a few percent, for example, ±10%.

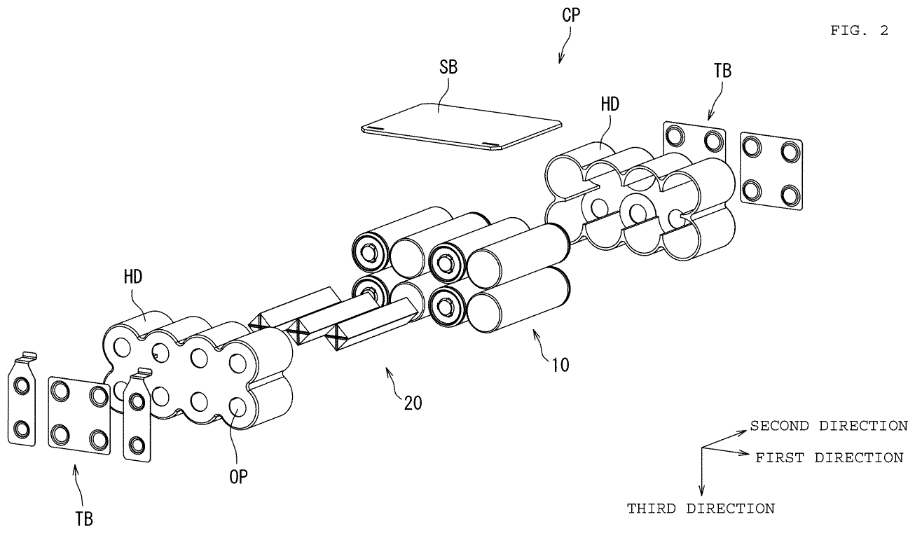

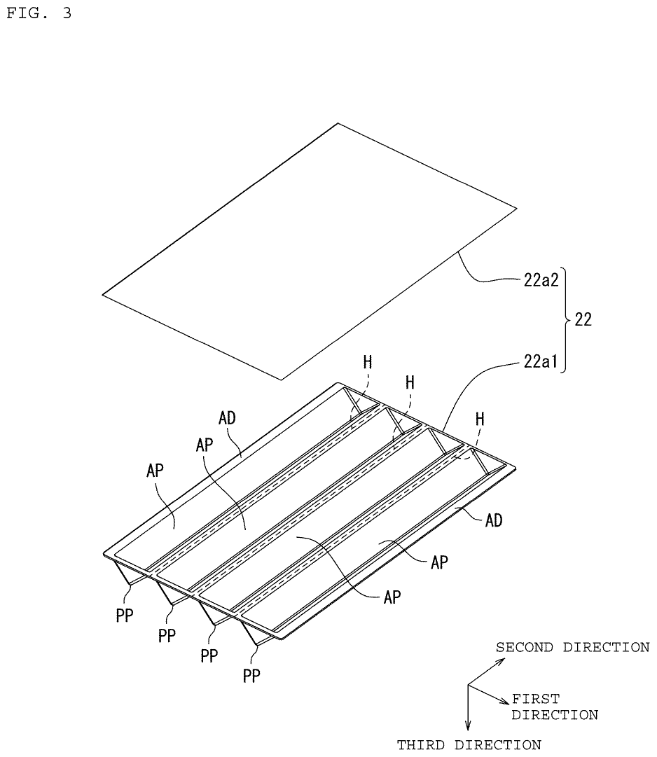

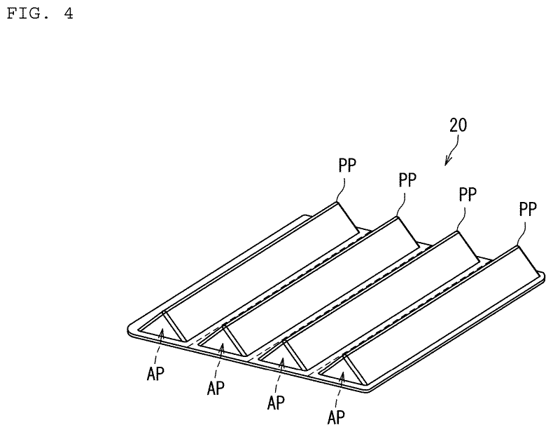

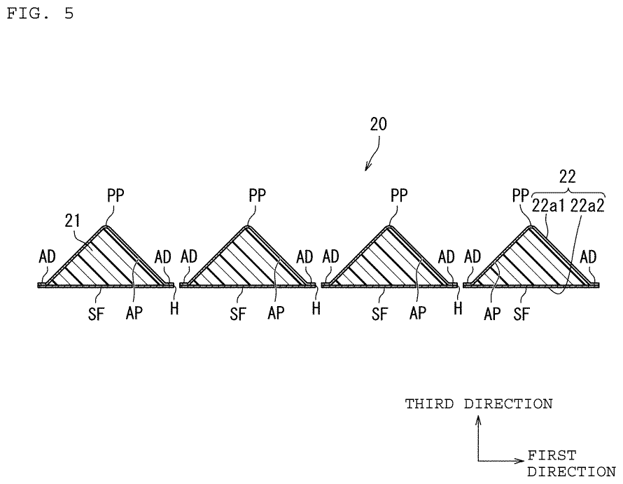

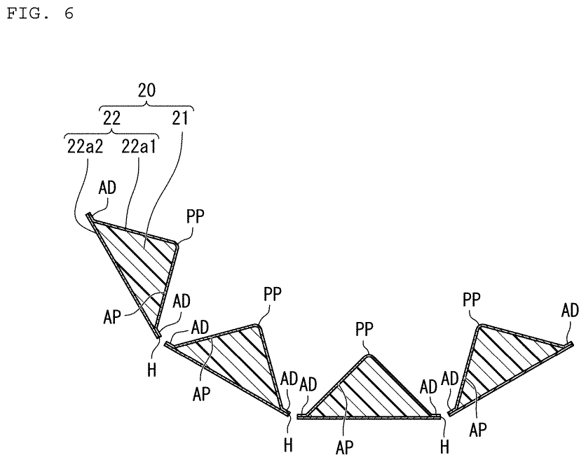

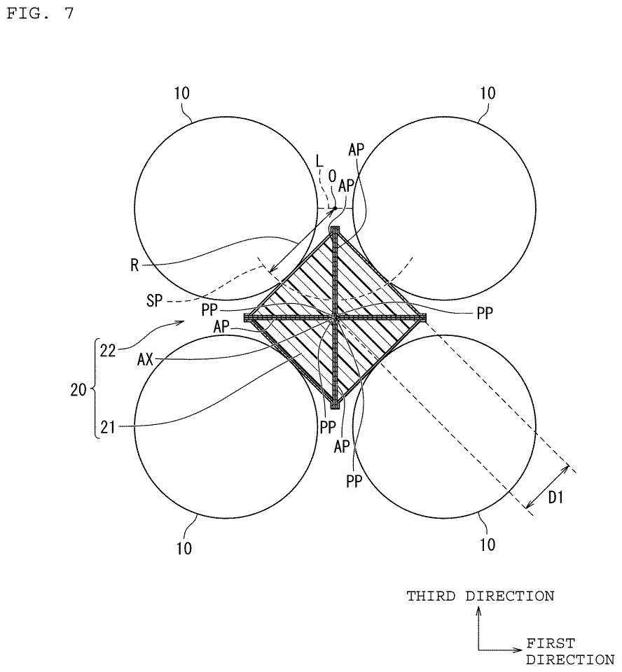

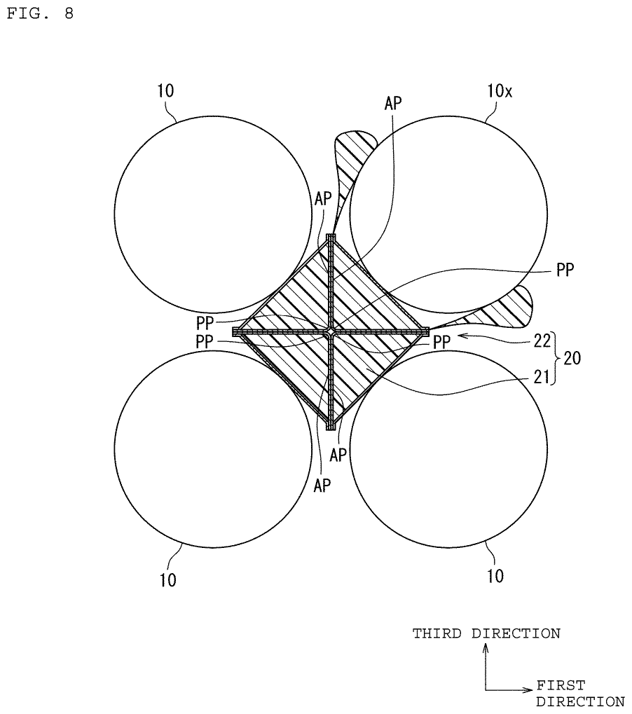

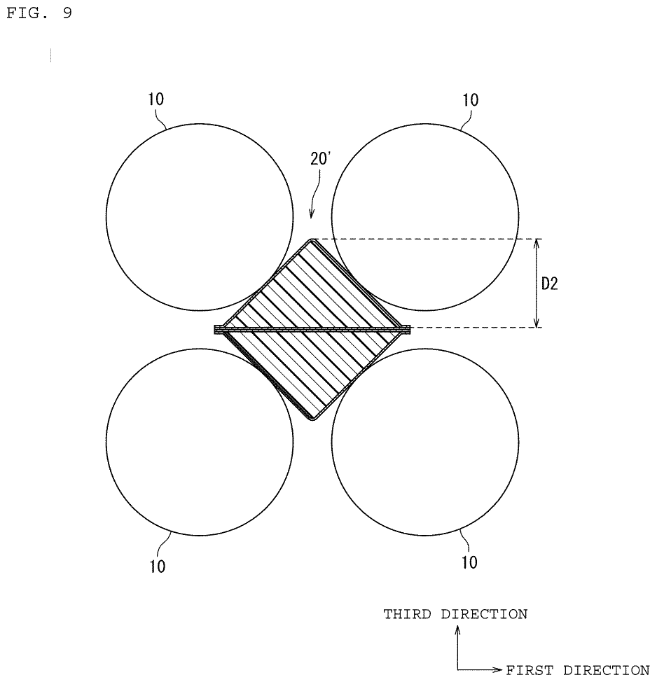

A battery pack 1 of the present disclosure will be described with reference to FIGS. 1 to 9. FIG. 1 is a schematic exploded perspective view of a battery pack 1, FIG. 2 is a schematic exploded perspective view of a core pack CP housed in the battery pack 1, FIG. 3 is a schematic exploded perspective view of a heat absorbing member 20 of a first embodiment, FIG. 4 is a schematic perspective view of the heat absorbing member 20 of the first embodiment, FIG. 5 is a schematic sectional view of the heat absorbing member 20 of the first embodiment, FIG. 6 is a schematic explanatory view for explaining a state in which the heat absorbing member 20 of the first embodiment is folded, FIG. 7 is a schematic sectional view of the main portion of the battery pack 1 of the present disclosure, FIG. 8 is a schematic sectional view of the main portion when an abnormality occurs in the battery pack, and FIG. 9 is a schematic sectional view of the main portion of a conventional battery pack.

The battery pack 1 may include a case CS and a core pack CP housed in the case CS (refer to FIGS. 1 and 2).

The case CS may include a first case CS1 and a second case CS2. The first case CS1 and the second case CS2 may form a housing space for housing the core pack CP. In the example of FIG. 1, an aspect in which the housing space includes two cases (the first case CS1 and the second case CS2) is exemplified, but the present invention is not limited to this aspect, and the housing space may include three or more cases.

A material of the case CS may be any material, and may be a resin material (for example, plastic) or a metal material. Examples of the resin material include polycarbonate resin (PC), acrylonitrile-butadiene-styrene resin (ABS), polybutylene terephthalate resin (PBT), modified polyphenylene ether resin (m-PPE), and polyamide resin (PA). Examples of the metal material include aluminum. From the viewpoint of more suitably housing the core pack CP, a material having high rigidity may be used for the case CS.

The case CS may be provided with a connector CN electrically connected to the core pack CP. The example illustrated in FIG. 1 illustrates an aspect in which the connector CN is provided in the second case CS2, but the connector CN may be provided in the first case CS1. The connector CN may be a terminal for extracting electric power from the core pack CP.

As illustrated in FIG. 2, the core pack CP may include a plurality of batteries 10, a heat absorbing member 20, a battery holder HD for holding and/or fixing the batteries 10 and the heat absorbing member 20 in the case CS, a tab TB electrically connected to a positive electrode or a negative electrode of the batteries 10, and a control board SB. The details of the battery 10 and the heat absorbing member 20 will be described in detail in the configuration of [Main portion of battery pack] described later.

The battery holder HD may be a member for holding and/or fixing the battery 10 and the heat absorbing member 20 in the housing space. In FIG. 2 illustrating an example, the battery holder HD is provided on the positive direction side and the negative direction side of battery 10 in the second direction. That is, the battery holder HD holds and/or fixes the core pack CP by being fitted into the battery 10 and the heat absorbing member 20 as the battery holder HD sandwiches the core pack CP and the battery 10 from both sides (the positive direction and the negative direction) in the second direction.

As illustrated in FIG. 2, the battery holder HD may be provided with an opening OP through which a positive terminal and a negative terminal of the battery 10 are exposed. The battery 10 (the positive terminal and the negative terminal) may be electrically connected to the tab TB through the opening OP.

A pair of tabs TB may be provided corresponding to the positive terminal and the negative terminal of the battery 10. A control board can be driven by supplying electric power from the battery 10 to a control board SB via the tab TB.

Then, the main portion of the battery pack 1 of the first embodiment (the battery 10 and the heat absorbing member 20) will be described in detail.

The battery 10 is intended to be a chemical battery that mainly converts chemical energy into direct current power by a chemical reaction. The battery 10 used in the battery pack 1 of the present embodiment is intended to be a cylindrical battery. Note that the shape of the battery may be a shape other than the cylindrical shape (for example, an elliptical cylindrical shape, a rectangular columnar shape, a polygonal columnar shape, or the like).

In the battery pack 1 of the present embodiment, two or more batteries 10 may be provided. In addition, the batteries 10 may be disposed adjacent to each other. For example, in the aspect illustrated in FIG. 7, four batteries 10 are disposed so as to be adjacent to each other.

The heat absorbing member 20 includes a heat absorbing agent 21 and a container 22 that accommodates the heat absorbing agent 21 (refer to FIG. 3 and FIG. 5). The heat absorbing member 20 is provided at a position adjacent to the battery 10 (refer to FIG. 7).

The heat absorbing agent 21 absorbs heat of the battery in a case where the battery has abnormally generated heat. As an example, the heat absorbing agent 21 contains a liquid such as water as a main component, and may contain a gelling agent such as sodium polyacrylate, a surfactant, and/or an anti-freezing agent.

The container 22 is a member for housing the heat absorbing agent 21. As an example, as illustrated in FIG. 3, the container 22 may have a first member 22a1 for defining the housing portion AP and a second member 22a2 for bonding to the first member 22a1 to seal the housing portion AP.

The first member 22a1 may be provided with a plurality of housing portions AP for housing the heat absorbing agent 21. In FIG. 3 illustrating an example, four housing portions AP are provided. Each housing portion AP has a hollow triangular prism shape before housing the heat absorbing agent 21, and one corner of the triangular prism shape is configured as a vertex portion PP. That is, one vertex portion PP is provided in each housing portion AP, and in the example illustrated in FIG. 3, four vertex portions PP are provided corresponding to the four housing portions AP.

The “triangular prism shape” used in the present specification is not limited to only a triangular prism shape in a strict sense, and may be intended to include a substantially triangular prism shape having a configuration corresponding to three surfaces of the triangular prism and two main surfaces intersecting the three surfaces or three corners. For example, the case where the three vertex corners protrude from the surface, are rounded off, or are flat and the case where the three surfaces are curved and/or bent may be included. In addition, the “vertex portion” may also have a protruding vertex, a rounded vertex, or a flat vertex.

The vertex portion PP may be provided by a surface including two sides constituting a triangle in a sectional view of the triangular prism shape. The vertex portion PP may extend along the positive direction of the second direction illustrated in FIG. 3. The housing portion AP having the vertex portion PP may be formed by pressing the first member 22a1. Instead of the method for forming the vertex portion PP by pressing one first member 22a1, a method for forming the vertex portion PP by bonding and then pressing two first members 22a1 may be adopted. In addition, as a method for forming the vertex portion PP, vacuum molding, pressure molding, or the like may be used in addition to pressing.

A bonding portion AD as a bonding position to the second member 22a2 may be provided around the housing portion AP (refer to FIGS. 3 and 5). The bonding portion AD is bonded to the second member 22a2, thereby allowing the housing portion AP to be sealed. As an example, the bonding between the bonding portion AD and the second member 22a2 may be performed by thermal welding or ultrasonic welding. Therefore, the first member 22a1 may be a thermally weldable material. Specifically, cast polypropylene (CPP), biaxially oriented polypropylene (OPP), linear low density polyethylene (LLDPE), and biaxially stretched nylon (ONy) may be used. In particular, as the material of the first member 22a1, cast polypropylene (CPP), biaxially oriented polypropylene (OPP), or linear low density polyethylene (LLDPE) is used, thereby allowing the chemical resistance of the first member to be improved. As a result, the life of the heat absorbing member can be extended.

As a preferred aspect of the first member 22a1, a metal layer (not illustrated) may be provided on the outer surface of the first member 22a1 (that is, the surface not facing the second member 22a2). Specific examples of the metal layer include an aluminum foil, a copper foil, and a stainless steel foil. Providing the metal layer on the outer surface of the first member 22a1 allows moisture of the heat absorbing agent housed in the container to hardly permeate and/or evaporate through the container. As a more preferred aspect, a resin layer may be provided on the outer surface of the metal layer. Examples of the material of the resin layer provided on the outer surface of the metal layer include polyethylene terephthalate (PET), cast polypropylene (CPP), biaxially oriented polypropylene (OPP), linear low density polyethylene (LLDPE), and biaxially stretched nylon (ONy). Further, as a preferred aspect, a laminate structure of resin/metal/resin may be used. Examples of the laminate structure include “PET/aluminum (Al)/polyethylene (PE)”, “nylon (Ny)/Al/PE”, and/or “PET/Al/Ny/CPP”. In the laminate structure described above, the left side intends an outer surface side of the container 22, and the right side intends an inner surface side of the container 22. The material of the resin layer provided on the outer surface of the metal layer may be the same as or different from the material of the first member 22a1. In particular, the material of the resin layer provided on the outer surface of the metal layer is polyethylene terephthalate (PET) or polyamide (PA), thereby allowing the weather resistance and impact resistance of the first member to be improved, and the weather resistance and impact resistance of the entire heat absorbing member to be improved.

In addition, as an aspect of the first member 22a1, a plurality of holes H may be provided along the longitudinal direction of the container 22 at positions between one housing portion AP of the plurality of housing portions AP and the other housing portion AP (refer to FIG. 3). The “plurality of holes H” in the present specification is not necessarily strictly disposed on a straight line along the longitudinal direction (second direction in FIG. 3) of the container 22, and may be disposed to be shifted in the positive direction or the negative direction of the first direction in FIG. 3. The plurality of holes H may be perforated. Providing the plurality of holes H allows the heat absorbing agent to be released from the holes to an abnormal battery when the abnormality occurs in the battery 10. Details when an abnormal battery occurs will be described later.

The plurality of holes H may be provided at positions between one housing portion AP of the plurality of housing portions AP and the other housing portion AP where the first member 22a1 and the second member 22a2 are bonded to each other (refer to FIGS. 3 and 5). When the plurality of holes H at such positions are provided, the bonding between the first member 22a1 and the second member 22a2 is peeled off, thereby allowing the heat absorbing agent to be effectively released from the plurality of holes when an abnormal battery occurs, which will be described in detail later.

The second member 22a2 is a member for sealing the housing portion AP in the first member 22a1 described above. The second member 22a2 may be a material that can be thermally welded to the first member 22a1. In addition, the second member 22a2 may be the same thermally weldable material as the first member 22a1 or may be a thermally weldable material different from the first member 22a1. In addition, a metal layer (not illustrated) may be provided on the outer surface (that is, the surface not facing the first member 22a1) of the second member 22a2 from the viewpoint of reducing evaporation of moisture of the heat absorbing agent. As a more preferred aspect, a resin layer may be provided on the outer surface of the metal layer. Examples of the material of the resin layer provided on the outer surface of the metal layer include polyethylene terephthalate (PET), cast polypropylene (CPP), biaxially oriented polypropylene (OPP), linear low density polyethylene (LLDPE), and biaxially stretched nylon (ONy). Further, as a preferred aspect, a laminate structure of resin/metal/resin may be used. Examples of the laminate structure include “PET/aluminum (Al)/polyethylene (PE)”, “nylon (Ny)/Al/PE”, and/or “PET/Al/Ny/CPP”. In the laminate structure described above, the left side intends an outer surface side of the container 22, and the right side intends an inner surface side of the container 22. The material of the resin layer provided on the outer surface of the metal layer may be the same as or different from the material of the first member 22a1. In particular, the material of the resin layer provided on the outer surface of the metal layer is polyethylene terephthalate (PET) or polyamide (PA), thereby allowing the weather resistance and impact resistance of the second member 22a2 to be improved, and the weather resistance and impact resistance of the entire heat absorbing member 20 to be improved.

In order to provide the container 22 in which the first member 22a1 and the second member 22a2 are bonded to each other in the battery pack 1, the container 22 of the present embodiment may be folded as illustrated in FIG. 6. Specifically, the folding may be performed with a straight line along a direction in which the vertex portion PP extends in the second direction positive direction as a starting point between the plurality of housing portions AP. As an example, the folding may be performed with a plurality of holes H provided along the longitudinal direction of the container 22 as starting points. In this manner, the container can be easily folded by using the plurality of holes H as starting points of folding.

The folded container 22 may be used as the heat absorbing member 20. The heat absorbing member 20 is disposed at a position adjacent to the battery 10. The term “adjacent” as used herein means that two different members face each other.

The vertex portions PP included in the heat absorbing member 20 are disposed at positions adjacent to each other, and two surfaces constituting the vertex portions PP are not adjacent to the battery 10. Therefore, when viewed as the entire heat absorbing member 20, the two surfaces constituting the vertex portion PP act as a reinforcing element that improves the mechanical strength of the heat absorbing member 20. Therefore, the mechanical strength of the battery pack can be improved as compared with the conventional battery pack (battery pack in which two surfaces of the triangular shape are adjacent to the battery) as shown in FIG. 9. As a result, it is possible to achieve effects of reducing deformation of the heat absorbing member when the heat absorbing member is incorporated into the battery pack and reducing deformation against vibration and/or impact during normal use of the battery pack.

In addition, when the vertex portion PP is formed by drawing, the vertex portion height D1 (refer to FIG. 7) of the heat absorbing member 20 constituted by the four containers 22 of the present embodiment can be made lower than the vertex portion height D2 of the conventional heat absorbing member 20′ constituted by the two containers as shown in FIG. 9. Therefore, occurrence of cracks and pinholes due to press working can be reduced.

As a preferred aspect of the first embodiment, the housing portions AP adjacent to each other may be in contact with each other (refer to FIG. 7). As described above, the mechanical strength inside the heat absorbing member can be further improved by the contact between the adjacent housing portions AP, and the heat absorbing member can be more hardly crushed.

As a preferred aspect, one of the two surfaces constituting the vertex portion PP may face one of the two surfaces constituting the other vertex portion PP (refer to FIGS. 6 and 7). With such a configuration, one of the two surfaces constituting the vertex portion PP can act as a support against the external stress applied to the heat absorbing member 20. Therefore, the mechanical strength to the heat absorbing member can be further improved, and the heat absorbing member can be more hardly crushed.

As a preferred aspect, the surface SF (refer to FIG. 5) facing the vertex portion PP may constitute the outer surface of the heat absorbing member 20. As used herein, the “surface facing the vertex portion” means a surface including opposite side with respect to the vertex portion PP in the housing portion AP having a triangular shape in the sectional view illustrated in FIG. 5. With such a configuration, a surface other than the surface facing the vertex portion can be a surface that improves the mechanical strength to the heat absorbing member.

In addition, as a preferred aspect, the sum of the angles formed by the vertex portions PP may be 360°. The “aspect in which the sum of the angles formed by the vertex portions PP is 360°” as used herein is not limited to 360° in a strict sense, and is intended to allow an error of about ±10% with respect to 360°. With such a configuration, the mechanical strength of the heat absorbing member can be further improved by combining the housing portions AP including the vertex portions PP.

In addition, as a preferred aspect, as illustrated in FIG. 7, the container 22 may have four housing portions AP, and may have a quadrangular prism outer shape in a folded state. The “quadrangular prism shape” used herein is not limited to a quadrangular prism shape in a strict sense, and may be intended to include a substantially quadrangular prism shape having a configuration corresponding to four surfaces of the quadrangular prism and two main surfaces intersecting the four surfaces, or four corners. For example, the case where the four corners protrude from the surface, the case where the four corners are rounded or flat, and the case where the four surfaces are curved and/or bent may be included. Then, when the container 22 is developed, it may have a triangular wave shape (refer to FIG. 4) in which the four housing portions AP are disposed in parallel. Herein, when the outer shape of the folded container 22 is a quadrangular prism shape, the respective vertex portions PP may be disposed at positions facing the central axis AX of the container 22 (refer to FIG. 7). With such a configuration, the respective vertex portions PP are disposed at positions facing the central axis AX of the container 22 inside the container 22 having a quadrangular prism shape in outer shape, and thus the surfaces constituting the respective vertex portions PP can act as elements for reinforcing the container 22, and the mechanical strength of the heat absorbing member can be further improved.

Operations and effects of the battery pack of the first embodiment configured as described above will be described with reference to FIG. 8. FIG. 8 illustrates a case where abnormal heat generation occurs in one battery 10x of four batteries.

Due to the heat generation of the battery 10x in which the abnormal heat generation occurs (hereinafter, may be also referred to as an abnormal-heat-generation battery), the heat is transferred to the container 22 in contact with the abnormal-heat-generation battery 10x, and peeling occurs at the thermally welded portion in the container 22. Damage due to heat may also occur in portions other than the thermally welded portions.

Then, the heat absorbing agent 21 is released from a place where the thermal welding is peeled off in the housing portion AP, and the released heat absorbing agent 21 is bonded to the battery (refer to FIG. 8). Therefore, the battery can be cooled by the adhesion of the heat absorbing agent 21, and the temperature rise of the battery can be suppressed.

As an aspect of efficiently releasing the heat absorbing agent 21, a plurality of holes H may be provided along the longitudinal direction of the container 22 at positions between one housing portion AP of the plurality of housing portions AP and the other housing portion AP and corresponding to corners of the container 22 (refer to FIG. 5). With such a configuration, the holes H are provided at the corners of the container 22 where peeling of thermal welding is likely to occur, and thus a larger amount of the heat absorbing agent released by peeling of thermal welding can be released through the holes.

In addition, the plurality of holes H may be provided at positions between one housing portion AP of the plurality of housing portions AP and the other housing portion AP where the first member 22a1 and the second member 22a2 are bonded to each other (refer to FIG. 5). With such a configuration, the plurality of holes H are provided at the positions where the first member 22a1 and the second member 22a2 are bonded to each other where peeling of thermal welding is particularly likely to occur, and thus a larger amount of the heat absorbing agent released by peeling of thermal welding can be released by the holes provided at the positions where the first member and the second member are bonded to each other.

In addition, the corner of the container 22 may be located in the vicinity of the central position O of the shortest distance (straight line L) between the outer peripheral surface of one of the plurality of batteries 10 and the outer peripheral surface of another battery (refer to FIG. 7). When the corner of the container 22 is specified from another viewpoint, the corner may be disposed in the inter-battery space SP (refer to FIG. 7) between one battery 10 and the other battery 10. As used herein, the “vicinity of the center position of the shortest distance” and/or the “inter-battery space” means the center position O of the shortest distance (straight line L) and a region up to a position away from the center position O by the radius R of the battery 10. Herein, an example of the optimum position of the corner of the container may be on an extension line of a straight line L where a space between one battery 10 and the other battery 10 becomes narrowest. The position of the first joint portion 25a is set as the above position, whereby the heat absorbing agent can be adhered to the battery at the place where the heat exchange between the batteries 10 is performed the most (the place where the distance between the batteries 10 is the narrowest), and thus the heat absorbing effect can be improved. In addition, when viewed along the negative direction in the third direction, the position of the corner of the container 22 may be disposed so as to overlap with the straight line L. Such a disposition may improve the heat absorbing effect.

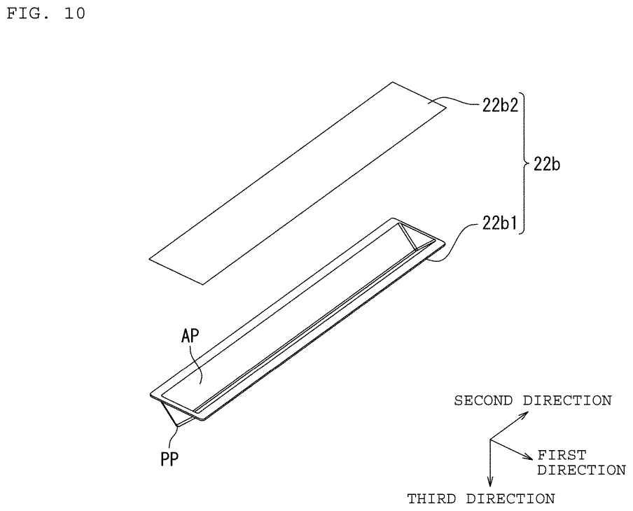

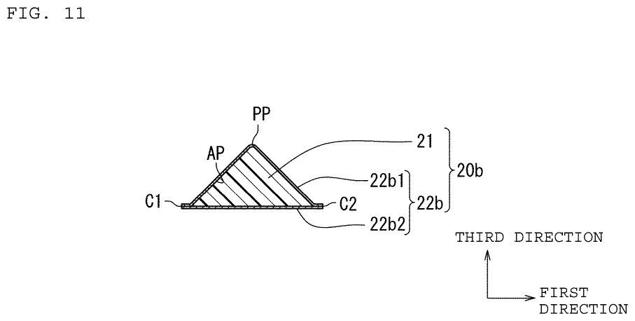

Then, a battery pack according to a second embodiment of the present disclosure will be described with reference to FIGS. 10 and 11. FIG. 10 is a schematic exploded perspective view of a heat absorbing member of a second embodiment, and FIG. 11 is a schematic perspective view of the heat absorbing member of the second embodiment. In addition, the schematic sectional view of the main portion of the battery pack of the second embodiment is the same as the schematic sectional view of the main portion illustrated in FIG. 7, and thus the schematic sectional view of the main portion of the battery pack of the second embodiment will be described with reference to FIG. 7.

Note that, in description of the battery pack of the second embodiment, the description of a point common to a configuration of the battery pack of the first embodiment will be appropriately omitted. That is, a configuration different from that of the battery pack of the first embodiment will be mainly described below.

The battery pack of the second embodiment is different from the battery pack 1 of the first embodiment in that a plurality of heat absorbing members 20b are provided.

The heat absorbing member 20b includes a heat absorbing agent 21 and a container 22b that accommodates the heat absorbing agent 21 (refer to FIG. 11).

The container 22b is a member that accommodates the heat absorbing agent 21. As an example, the container 22b may have a first portion 22b1 that defines the housing portion AP and a second portion 22b2 that is bonded to the first portion 22b1 to seal the housing portion AP.

The first portion 22b1 may be provided with the housing portion AP that houses the heat absorbing agent 21. In FIGS. 10 and 11 illustrating an example, one housing portion AP is provided. The housing portion AP has a hollow triangular prism shape before housing the heat absorbing agent 21, and one corner of the triangular prism shape is configured as a vertex portion PP.

The second portion 22b2 is a member that seals the housing portion AP in the first portion 22b1 described above. The second portion 22b2 may be a material that can be thermally welded to the first portion 22b1.

As an example, four containers 22b in which the first portion 22b1 and the second portion 22b2 are bonded to each other are combined to constitute the battery pack of the second embodiment. That is, in the present embodiment, the vertex portion PP of one container 22 and the vertex portion PP of the other container 22 are disposed at positions adjacent to each other, the two surfaces constituting the vertex portion PP are not adjacent to the battery, and the adjacent heat absorbing members 20 are in contact with each other, thereby constituting the battery pack corresponding to FIG. 7.

In the battery pack of the second embodiment, the two surfaces constituting the vertex portion PP act as a reinforcing element that improves the mechanical strength of the assembly of the heat absorbing members 20. Therefore, compared with the conventional battery pack 1 (battery pack in which two surfaces of the triangular shape are adjacent to the battery) as shown in FIG. 9, the mechanical strength of the battery pack can be improved. As a result, it is possible to achieve effects of reducing deformation of the heat absorbing member when the assembly of the heat absorbing member is incorporated into the battery pack and reducing deformation against vibration and/or impact during normal use of the battery pack.

A more specific aspect of the battery pack of the second embodiment may have four or more batteries 10, each having a cylindrical shape, and the four batteries 10 may be disposed at positions adjacent to each other (refer to FIG. 7). An assembly of four heat absorbing members 20 may be disposed in a space surrounded by the battery 10. The outer shape of the assembly may be a quadrangular prism shape, and the vertex portions PP of the respective containers 22b may be disposed at positions adjacent to each other (refer to FIG. 7). With such a configuration, the respective vertex portions PP are disposed at positions adjacent to each other inside the assembly of the containers 22b having a quadrangular prism shape in outer shape, and thus the surfaces of the containers 22b constituting the respective vertex portions can act as elements for reinforcing the assembly, thereby allowing the mechanical strength to be further improved.

In addition, each container 22b may have a first portion 22b1 and a second portion 22b2. The first portion 22b1 of the present embodiment is common to the first member 22a1 of the first embodiment except that there is one housing portion AP. The second portion 22b2 of the present embodiment is common to the second member 22a2 of the first embodiment except that one housing portion AP is sealed. In the present embodiment, the vertex portion PP is provided in the first portion. Then, the first portion 22b1 and the second portion 22b2 are bonded at the positions of the first corner portion C1 and the second corner portion C2 in the container 22 (refer to FIG. 11). As described above, the bonding method may be performed by thermal welding or ultrasonic welding. The first corner portion C1 and the second corner portion C2 are located in the vicinity of a center position O of a shortest distance (straight line L illustrated in FIG. 7) between an outer peripheral surface of one battery 10 among the plurality of batteries 10 and an outer peripheral surface of another battery 10. With such a positional relationship, the endothermic effect can be improved.

The embodiments disclosed herein are illustrative in all respects, and do not provide a basis for restrictive interpretations. Therefore, the technical scope of the present disclosure is not to be construed only by the above-described embodiments, but is defined based on the recitation of the claims. In addition, the technical scope of the present disclosure includes meanings equivalent to the claims and all modifications within the scope.

The present disclosure is described in further detail as follows.

<1> A battery pack including:
a plurality of batteries; and
a heat absorbing member having a heat absorbing agent and a container for housing the heat absorbing agent, in which
the heat absorbing member is disposed at a position adjacent to the battery,
the container has a triangular prism shape and has a plurality of housing portions for housing the heat absorbing agent, and
respective vertex portions of the housing portions having the triangular prism shape are disposed at positions adjacent to each other and two surfaces constituting the vertex portion are not adjacent to the battery.

<2> The battery pack according to <1>, in which the container is folded with a straight line between the plurality of housing portions and along a direction in which the vertex portion extends as a starting point.

<3> The battery pack according to <1> or <2>, in which the adjacent housing portions are in contact with each other.

<4> The battery pack including:
a plurality of batteries; and
a plurality of heat absorbing members each having a heat absorbing agent and a container for housing the heat absorbing agent, in which
each of the plurality of heat absorbing members is disposed at a position adjacent to one of the plurality of batteries;
each of the plurality of containers has a triangular prism shape, one vertex portion of one container having the triangular prism shape and one vertex portion of the other container having the triangular prism shape are disposed at positions adjacent to each other and two surfaces constituting the vertex portion are not adjacent to the battery; and
the adjacent heat absorbing members are in contact with each other.

<5> The battery pack according to any one of <1> to <4>, in which one of two surfaces constituting the vertex portion is opposed to one of the two surfaces constituting the other vertex portion.

<6> The battery pack according to any one of <1> to <5>, in which a surface facing the vertex portion constitutes an outer surface of the heat absorbing member.

<7> The battery pack according to any one of <1> to <6>, in which a sum of angles formed by the vertex portions is 360°.

<8> The battery pack according to any one of <1> to <3> and <5> to <7>, in which
the container has four of the housing portions, an outer shape of a quadrangular prism shape, and a triangular wave shape with the four housing portions disposed in parallel when developed, in which
the container when the outer shape is the quadrangular prism shape is disposed at a position where each of the vertex portions faces a central axis of the container, and
a plurality of holes are provided along a longitudinal direction of the container at positions corresponding to corners of the container between one housing portion and the other housing portion among the plurality of housing portions.

<9> The battery pack according to <8>, in which
the container includes a first member defining the housing portion and a second member,
the first member is provided with the plurality of vertex portions,
the first member and the second member are bonded to each other, and
the plurality of holes are provided at positions between one housing portion and the other housing portion of the plurality of housing portions, the positions at which the first member and the second member are bonded to each other.

<10> The battery pack according to <9>, in which a position corresponding to a corner of the container is located in the vicinity of a central position of a shortest distance between an outer peripheral surface of one of the plurality of batteries and an outer peripheral surface of the other battery.

<11> The battery pack according to <4> and any one of claims <5> to <7> which cite claim <4>, in which
four or more of the batteries each have a cylindrical shape,
the four batteries are disposed at positions adjacent to each other,
an assembly of four of the heat absorbing members is disposed in a space surrounded by the batteries,
an outer shape of the assembly is a quadrangular prism shape, and
the vertex portions of the respective containers are disposed at positions facing each other.

<12> The battery pack according to any one of <4>, <5> to <7> which cite <4>, and <11>, in which
the container has a first portion and a second portion,
the first portion is provided with the vertex portion,
the first portion and the second portion are bonded at positions of a first corner portion and a second corner portion in the container, and
the first corner portion and the second corner portion are located in a vicinity of a central position of a shortest distance between an outer peripheral surface of one of the plurality of batteries and an outer peripheral surface of the other battery.

The present disclosure can be used as a battery pack in which the mechanical strength of a container for housing a heat absorbing agent is further improved, and deformation of the container when the heat absorbing agent is housed in the container, and deformation of the container against vibration and impact during normal use of the battery pack are further reduced according to an embodiment.

### DESCRIPTION OF REFERENCE SYMBOLS

1: Battery pack
10: Battery
20 20′, 20b: Heat absorbing member
21: Heat absorbing agent
22: Container
22a1: First member
22a2: Second member
22b1: First portion
22b2: Second portion
AP: Housing portion
PP: Vertex portion
AD: Bonding portion
H: Hole
CP: Core pack
CS: Case
CS1: First case
CS2: Second case
HD: Battery holder
TB: Tab
OP: Opening
SB: Control board
D1, D2: Drawing depth
O: Center position
L: Straight line
SF: Surface facing vertex portion

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a plurality of batteries; and
a heat absorbing member having a heat absorbing agent and a container for housing the heat absorbing agent, wherein
the heat absorbing member is disposed at a position adjacent to the battery,
the container has a triangular prism shape and has a plurality of housing portions for housing the heat absorbing agent, and
respective vertex portions of the housing portions having the triangular prism shape are disposed at positions adjacent to each other and two surfaces constituting the vertex portion are not adjacent to the battery.

2. The battery pack according to claim 1, wherein the container is folded with a straight line between the plurality of housing portions and along a direction in which the vertex portion extends as a starting point.

3. The battery pack according to claim 1, wherein the adjacent housing portions are in contact with each other.

4. The battery pack comprising:
a plurality of batteries; and
a plurality of heat absorbing members each having a heat absorbing agent and a container for housing the heat absorbing agent, wherein
each of the plurality of heat absorbing members is disposed at a position adjacent to one of the plurality of batteries;
each of the plurality of containers has a triangular prism shape, one vertex portion of one container having the triangular prism shape and one vertex portion of the other container having the triangular prism shape are disposed at positions adjacent to each other and two surfaces constituting the vertex portion are not adjacent to the battery; and
the adjacent heat absorbing members are in contact with each other.

5. The battery pack according to claim 1, wherein one of two surfaces constituting the vertex portion is opposed to one of the two surfaces constituting the other vertex portion.

6. The battery pack according to claim 1, wherein a surface facing the vertex portion constitutes an outer surface of the heat absorbing member.

7. The battery pack according to claim 1, wherein a sum of angles formed by the vertex portions is 360°.

8. The battery pack according to claim 1, wherein
the container has four of the housing portions, an outer shape of a quadrangular prism shape, and a triangular wave shape with the four housing portions disposed in parallel when developed, wherein
the container with an outer shape being the quadrangular prism shape has each of the vertex portions disposed at a position where it faces a central axis of the container, and
a plurality of holes are provided along a longitudinal direction of the container at positions corresponding to corners of the container between one housing portion and the other housing portion among the plurality of housing portions.

9. The battery pack according to claim 8, wherein
the container includes a first member defining the housing portion and a second member,
the first member is provided with the plurality of vertex portions,
the first member and the second member are bonded to each other, and
the plurality of holes are provided at positions between one housing portion and the other housing portion of the plurality of housing portions, the positions at which the first member and the second member are bonded to each other.

10. The battery pack according to claim 9, wherein a position corresponding to a corner of the container is located in the vicinity of a central position of a shortest distance between an outer peripheral surface of one of the plurality of batteries and an outer peripheral surface of the other battery.

11. The battery pack according to claim 4, wherein
the plurality of batteries includes four or more of the batteries each having a cylindrical shape,
the four batteries are disposed at positions adjacent to each other,
an assembly of four of the heat absorbing members is disposed in a space surrounded by the batteries,
an outer shape of the assembly is a quadrangular prism shape, and
the vertex portions of the respective containers are disposed at positions facing each other.

12. The battery pack according to claim 4, wherein
the container has a first portion and a second portion,
the first portion is provided with the vertex portion,
the first portion and the second portion are bonded at positions of a first corner portion and a second corner portion in the container, and
the first corner portion and the second corner portion are located in a vicinity of a central position of a shortest distance between an outer peripheral surface of one of the plurality of batteries and an outer peripheral surface of the other battery.
